(19) United States
(12) Patent Application Publication
(10) Pub. No.: US 2007/0213473 A1
(43) Pub. Date: Sep. 13, 2007

(54) Composition and method of use

(76) Inventors: Claire Qing Yu, Chicago, IL (US); Dominique Arnould, Steenbergseweg (NL); Kenneth Frederick Miller, Posey, IN (US); Sung Dug Kim, Newburgh, IN (US); Ning Lu, White Plains, NY (US)

Correspondence Address: GEAM - O8CV - CPP;IP LEGAL, ONE PLASTICS AVENUE, PITTSFIELD, MA, 01201-3697, US

(21) Appl. No.: 11/371,876

(22) Filed: Mar. 9, 2006

(51) Int. Cl. C08G 63/91

(52) U.S. Cl. 525/446; 528/26; 528/29

(57) ABSTRACT

A method for improving at least one property of a polyester, the property selected from the group consisting of impact strength, color, or tensile modulus of a polyester comprising reacting the polyester with an epoxy silane wherein the epoxy is attached to a terminal cycloaliphatic ring system, the reaction product having improved at least one of the properties of impact strength, color, and tensile modulus.

### BACKGROUND OF THE INVENTION

Polyesters are well known in polymer chemistry for many decades. Among the properties for which polyesters are known are electrical, HDT, flow rate, solvent resistance, and the like. When used in blends with the materials such as polycarbonates, impact modifiers and the like, it is usually the above-mentioned polyester properties which are sought after.

We have now found that a polyester's [polybutylene terephthalate (PBT)] basic properties of impact strength, color, and tensile modulus can be significantly improved when the polyester is contacted with an epoxysilane, wherein the epoxy is attached to a terminal cycloaliphatic ring system. When the epoxy is attached to a normal alkylene group, no significant improvement in these properties is observed.

### SUMMARY OF THE INVENTION

In accordance with the invention there is a method for improving at least one of the properties of impact strength, color, and tensile modulus of a polyester comprising reacting the polyester with an epoxy silane wherein the epoxy is attached to a terminal cycloaliphatic ring system, the reaction product having improved at least one of the properties of impact strength, color, and tensile modulus.

Additionally, there is a composition comprising a polyester reacted with an epoxysilane, the product of said reaction having improved at least one of the properties of impact strength, color, and tensile modulus compared to the initial polyester.

### DETAILED DESCRIPTION OF THE INVENTION

The singular forms “a”, “an”, and “the” include plural referents unless the context clearly dictates otherwise.

“Optional” or “optionally” as used herein means that the subsequently described event may or may not occur, and that the description includes instances where the event occurs and the instances where it does not occur.

Any polyester can be the initial polyester provided it has carboxyl and/or alcohol end groups available for reaction with the epoxy silane. Such polyesters include those comprising structural units of formula 1: 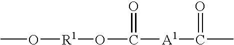
wherein each R¹ is independently a divalent aliphatic, alicyclic or aromatic hydrocarbon or polyoxyalkylene radical, or mixtures thereof and each A¹ is independently a divalent aliphatic, alicyclic or aromatic radical, or mixtures thereof. Examples of suitable polyesters containing the structure of the above formula are poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometimes desirable to have various concentrations of acid and hydroxyl end groups on the polyester, depending on the ultimate end-use of the composition.

The R¹ radical may be, for example, a C₂₋₁₀ alkylene radical, a C₆₋₁₂ alicyclic radical, a C₆₋₂₀ aromatic radical or a polyoxyalkylene radical in which the alkylene groups contain about 2-6 and most often 2 or 4 carbon atoms. The A¹ radical in the above formula is most often p- or m-phenylene, a cycloaliphatic or a mixture thereof. This class of polyesters includes the poly(alkylene terephthalates). Such polyesters are known in the art as illustrated by the following patents, which are incorporated herein by reference.

U.S. Pat. Nos. 2,465,319 2,720,502 2,727,881 2,822,348 3,047,539 3,671,487 3,953,394 4,128,526

Examples of aromatic dicarboxylic acids represented by the dicarboxylated residue A¹ are isophthalic or terephthalic acid, 1,2-di(p-carboxyphenyl)ethane, 4,4′-dicarboxydiphenyl ether, 4,4′ bisbenzoic acid and mixtures thereof. Acids containing fused rings can also be present, such as in 1,4-1,5- or 2,6-naphthalenedicarboxylic acids. The preferred dicarboxylic acids are terephthalic acid, isophthalic acid, naphthalene dicarboxylic acid, cyclohexane dicarboxylic acid or mixtures thereof.

The most preferred polyesters are poly(ethylene terephthalate) (“PET”), poly(1,4-butylene terephthalate) (“PBT”), poly(ethylene naphthanoate) (“PEN”), poly(butylene naphthanoate) (“PBN”), (polypropylene terephthalate) (“PPT”), poly(1,4-10 cyclohexylenedimethylene 1,4-cyclohexanedicarboxylate) (“PCCD”), poly(1,4-cyclohexylenedimethylene terephthalate) (“PCT”), poly(cyclohexylenedimethylene-co-ethylene terephthalate) (“PCTG”), and mixtures thereof.

Also contemplated herein are the above polyesters with minor amounts, e.g., from about 0.5 to about 5 percent by weight, of units derived from aliphatic acid and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The epoxy silane which is contacted with and reacts with the polyester is generally any kind of epoxy silane wherein the epoxy is at one end of the molecule and attached to a cycloaliphatic group and the silane is at the other end of the molecule. A desired epoxy silane within that general description is of formula 2. 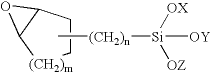
wherein m is an integer 1, 2 or 3, n is an integer of 1 through 6 and X, Y, and Z are the same or different, preferably the same and are alkyl of one to twenty carbon atoms, inclusive, cycloalkyl of four to ten carbon atoms, inclusive, alkylene phenyl wherein alkylene is one to ten carbon atoms, inclusive, and phenylene alkyl wherein alkyl is one to six carbon atoms, inclusive.

Desirable epoxy silanes within the range are compounds wherein m is 2, n is 1 or 2, desirably 2, and X, Y, and Z are the same and are alkyl of 1, 2, or 3 carbon atoms inclusive. Epoxy silanes within the range which in particular can be used are those wherein m is 2, n is 2, and X, Y, and Z are the same and are methyl or ethyl.

The polyester modified with the epoxy silane can be blended with any of the usual additives and property modifier that polyesters are usually mixed for example glass, clay, mica and the like. Polymer blends can be made with reacted polyester or can be made with the unreacted polyester and the polyester then reacted with the epoxy silane during the blending or extrusion process. Examples of polymer which can be blended include aromatic polycarbonates, polysulfones, polyethesulfones, impact modifiers, and the like.

The epoxy silane is reacted with the polyester by simply bringing the two components together at a temperature and time period. For example, PBT 195, Intrinsic Viscosity (IV) 1.1 from GE together with PBT 315, IV 0.7 from GE are tumble blended with various additives such as potassium diphenylsulfone sulfonate (KSS), a flame retardant, a hindered phenol such as Irganox 1010 from Ciba Geigy, a catalyst such as sodium stearate, a mold release such as pentaerythritol tetrastearate (PETS) and the epoxy silane beta-(3,4-epoxycyclohexyl)ethyl triethoxysilane Coatosil 1770 from GE and then extruded in a 27 mm twin screw with a vacuum vented mixing screw at a barrel and die head temperature between 240 and 265 degrees Celsius and 450 ppm screw speed. The extrudate is cooled through a water bath prior to palletizing.

The quantities of epoxy silane employed as a percentage of polyester present in the composition is generally at least about 0.1 wt % and a minimum of about 0.4 wt % can also be employed. Generally, further increases in desirable properties are not observable beyond a maximum of about 5.0 wt %, but further quantities can be used if desired.

Various processes can be used to bring about a desired final product. Injection molding, blow molding, compression molding, resin transfer molding, and the like are processes which can be employed.

As noted previously various properties can be improved such as impact strength, color, and tensile modulus through the use of the epoxy silane. Virtually any part for an application can benefit from one or a combination of at least two of these properties. For instance, in one embodiment, with respect to the impact strength, a reaction product has an improved impact strength that is at least 10%, as compared to a reaction product that does not contain the epoxy silane, measured with Notched IZOD or DYNATUP impact testing techniques. In another embodiment, the improved impact strength can range from 10 to 30%, or more, as compared to a reaction product that does not contain the epoxy silane, measured with Notched IZOD or DYNATUP impact testing techniques. With respect to improved color properties imparted by the epoxy silane to an opaque reaction product, an opaque reaction product of the invention can have a reduced Yellowness Index by Reflectance (YIR) of at least two units, as compared to a reaction product that does not contain the epoxy silane. In another embodiment, an opaque reaction product of the invention can have a reduced Yellowness Index by Reflectance (YIR) from two to eleven units, or more, as compared to a reaction product that does not contain the epoxy silane. With respect to improved color properties imparted by the epoxy silane to a transparent reaction product, a transparent reaction product of the invention can have a reduced Yellowness Index (YI) of at least one unit, as compared to a reaction product that does not contain the epoxy silane. In another embodiment, a transparent reaction product of the invention can have a reduced Yellowness Index (YI) from one to eleven units, or more, as compared to a reaction product that does not contain the epoxy silane. With respect to tensile modulus, a reaction product has an improved tensile modulus that is at least 5%, as compared to a reaction product that does not contain the epoxy silane, measured with tensile testing techniques. In another embodiment, the improved tensile strength can range from 5 to 10%, or more, as compared to a reaction product that does not contain the epoxy silane, measured with tensile testing techniques.

Below are examples of the invention. These examples relative to their control comparisons show significant improvement in the above-identified areas. Additionally tensile elongation at break in the non-glass filled PBT and tensile elongation at yield in the glass filled PBT shows improvements. These improvements are indeed selective as noted by other tests providing virtually no improvement or potentially some small declines in tested values.

Tensile properties were tested according to ASTM D648 using Type 1 tensile bars at room temperatures with a crosshead speed of 2 in/min.

Izod testing was done on 3×½×⅛ inch bars according to ASTM D256.

Yellowness Index (YI) was tested according to ASTM E313-00.

Yellowness Index by Reflectance (YIR)— This is computed from the spectrophotometric reflectance data of an opaque specimen, which indicates the degree of departure of an object from colorless or from a preferred white, towards yellow. A spectrophotometric method is employed. Acceptable test samples are free from dust, grease, scratches, and visible molding defects. Samples are molded and must have plane-parallel surfaces. Spectrophotometer is a Minolta CM-3600 Spectrophotometer with SpectaMatch software configured for simultaneous capture of YI, % T, and % Haze using Illuminant C—North Sky Daylight and 2° Standard Observer settings. All test specimens are to be conditioned at 23±2° C. relative humidity for not less that 40 hours prior to testing. YIR tests are to be performed in a reflectance mode. A white calibration tile backs the test specimen during testing. YIR is reported to 0.1.

Results

TABLE 1
Color comparison of PBT resin with and without epoxysilane

| Component | Unit | C1 | E1 | C2 | E2 |
|---|---|---|---|---|---|
| PBT 315 | % | 99.94 | 98.44 | 0.0 | 0.0 |
| PBT 195 | % | 0.0 | 0.0 | 99.94 | 98.44 |
| CoatoSil 1770 | % | 0.0 | 1.5 | 0.0 | 1.5 |
| NaSt | % | 0.01 | 0.01 | 0.01 | 0.01 |
| Irg 1010 | % | 0.05 | 0.05 | 0.05 | 0.05 |
| YIR | | 13.3 | 8.4 | 17.1 | 6.1 |

As seen in Table 1, the addition of epoxysilane Coatosil 1770 significantly reduces the YIR of PBT resin in molded parts. Additionally, the YIR is reduced in pellets as well. The examples shown in Table 1 (E1 and E2) both have 1.5% epoxysilane loading, but similar YIR-reduction were observed when the epoxysilane loading were lower or higher.

TABLE 2
Effect of epoxysilane on mechanical properties of unfilled PBT

| Properties | Unit | C1 | E1 | C2 | E2 |
|---|---|---|---|---|---|
| Notched | lbf/in | 0.8 | 1.093 | 0.781 | 1.033 |
| IZOD | | | | | |
| Unnotched | lbf/in | 33.5 | 39.2 | 39.2 | 35.4 |
| IZOD | | | | | |
| Dynatup | Ft-lbf | 43.1 | 49.3 | 32.7 | 39.5 |
| total | | | | | |
| energy | | | | | |
| Flex | PSI | 12200 | 12900 | 12900 | 12100 |
| strength | | | | | |
| Flex | PSI | 355000 | 389000 | 367000 | 351000 |
| modulus | | | | | |
| Tensile | PSI | 8380 | 8290 | 8350 | 8270 |
| strength | | | | | |
| at yield | | | | | |
| Tensile | % | 3.30 | 2.94 | 3.30 | 3.02 |
| elongation | | | | | |
| at yield | | | | | |
| Tensile | PSI | 4250 | 5710 | 5860 | 5280 |
| strength | | | | | |
| at break | | | | | |
| Tensile | % | 162 | 218 | 71.3 | 129.2 |
| elongation | | | | | |
| at break | | | | | |
| Tensile | PSI | 409000 | 444000 | 404000 | 430000 |
| Modulus | | | | | |
| Vicat | C. | 172 | 183 | | |

TABLE 3
Effect of epoxysilane on mechanical properties of glass-filled PBT

| Component | Unit | C3 | E5 | E6 | C4 | E7 | E8 |
|---|---|---|---|---|---|---|---|
| PBT 315 | % | 69.94 | 68.94 | 67.94 | 0.0 | 0.0 | 0.0 |
| PBT 195 | % | 0.0 | 0.0 | 0.0 | 69.94 | 68.94 | 67.94 |
| Chopped Glass Fiber | % | 30.0 | 30.0 | 30.0 | 30.0 | 30.0 | 30.0 |
| CoatoSil 1770 | % | 0.0 | 1.0 | 2.0 | 0.0 | 1.0 | 2.0 |
| NaSt | % | 0.01 | 0.01 | 0.01 | 0.01 | 0.01 | 0.01 |
| Irg 1010 | % | 0.05 | 0.05 | 0.05 | 0.05 | 0.05 | 0.05 |
| Notched IZOD | lbf/in | 1.58 | 2.17 | 1.83 | 1.37 | 1.46 | 1.58 |
| Unnotched IZOD | lbf/in | 16.2 | 17.2 | 16.3 | 11.3 | 13.7 | 17.6 |
| Dynatup total energy | Ft-lbf | 6.7 | 6.6 | 7.0 | 4.9 | 5.9 | 7.8 |
| Flex strength | PSI | 25900 | 28600 | 28700 | 25700 | 27400 | 28400 |
| Flex modulus | PSI | 1160000 | 1180000 | 1240000 | 1200000 | 1170000 | 1190000 |
| Tensile strength at yield | PSI | 17400 | 18600 | 18700 | 17400 | 18900 | 19600 |
| Tensile elongation at yield | % | 2.62 | 3.02 | 3.18 | 1.76 | 2.18 | 2.58 |
| Tensile Modulus | PSI | 1990000 | 2300000 | 2480000 | 2170000 | 2090000 | 2140000 |
| Vicat | C. | 215.6 | 216.7 | 214.8 | 210.2 | 210.3 | 212.3 |

As shown in Table 3, the addition of epoxysilane Coatosil 1770 improves the modulus and impact property in both glass-filled and un-filled PBT, especially in materials based on PBT 315.

TABLE 4
Color comparison of PCTG resin with and without epoxysilane

| Component | Unit | C5 | E9 | E10 |
|---|---|---|---|---|
| PBT 315 | % | 99.94 | 97.94 | 96.94 |
| CoatoSil 1770 | % | 0.0 | 2.0 | 3.0 |
| NaSt | % | 0.01 | 0.01 | 0.01 |
| Irg 1010 | % | 0.05 | 0.05 | 0.05 |
| YI | | 3.15 | 0.53 | 0.71 |
| % Transmission | % | 85.0 | 86.1 | 85.6 |

As seen in Table 4, the addition of epoxysilane Coatosil 1770 significantly reduces the YI of PCTG resin in molded parts. Additionally, the YI is reduced in pellets as well. The examples shown in Table 4 (E9 and E10) have epoxysilane loading of 2.0% and 3.0%, respectively, but similar YI-reduction were observed when the epoxysilane loading were lower or higher.

TABLE 5
Effect of epoxysilane on mechanical properties of PCTG

| Properties | Unit | C5 | E9 | E10 |
|---|---|---|---|---|
| Notched IZOD | lbf/in | 26.9 | 7.1 | 6.9 |
| Impact Strength | | | | |
| Unnotched | lbf/in | 27.0 | 33.6 | 37.6 |
| IZOD Impact | | | | |
| Strength | | | | |
| Dynatup total | Ft-lbf | 45.6 | 47.7 | 51.3 |
| energy | | | | |
| Flex strength | PSI | 9380 | 9450 | 9574 |
| Tensile strength | PSI | 6340 | 6500 | 6580 |
| at yield | | | | |
| Tensile | % | 4.94 | 4.55 | 4.30 |
| elongation | | | | |
| at yield | | | | |
| Tensile strength | PSI | 5710 | 4360 | 4200 |
| at break | | | | |
| Tensile | % | 163.28 | 115.65 | 124.33 |
| elongation | | | | |
| at break | | | | |
| Tensile Modulus | PSI | 238000 | 250000 | 255000 |

As shown in Table 5, the addition of epoxysilane Coatosil 1770 improves the unnotched IZOD impact strength and Dynatup impact property in PCTG.

What is claimed is:

1. A method for improving at least one property of a polyester, the property selected from the group consisting of impact strength, color, or tensile modulus of a polyester comprising reacting the polyester with an epoxy silane wherein the epoxy is attached to a terminal cycloaliphatic ring system, the reaction product having improved at least one of the properties of impact strength, color, and tensile modulus.

2. The method in accordance with claim 1 wherein the property is impact strength.

3. The method in accordance with claim 1 wherein the property is color.

4. The method in accordance with claim 1 wherein the property is tensile modulus.

5. The method in accordance with claim 1 wherein the polyester is polybutylene terephthalate.

6. The method in accordance with claim 1 wherein accompanying the polyester is at least one other polymer.

7. The method in accordance with claim 1 wherein the epoxy is at least about 0.1 wt % of the polyester.

8. The method in accordance with claim 1 wherein the epoxy silane has a silane group at the other end of the molecule.

9. The method in accordance with claim 5 wherein the epoxy silane has a silane group at the other end of the molecule.

10. The method in accordance with claim 8 wherein the epoxysilane is beta-(3,4-epoxycyclohexyl)ethyl triethoxysilane.

11. The method in accordance with claim 9 wherein the epoxysilane is beta-(3,4-epoxycyclohexyl)ethyl triethoxysilane.

12. A composition comprising a polyester reacted with an epoxysilane, the product of said reaction having improved at least one of the properties of impact strength, color, and tensile modulus.

13. The composition in accordance with claim 12; wherein the polyester is selected from the group consisting of poly(1,4-butylene terephthalate), poly(ethylene naphthanoate), poly(butylene naphthanoate), poly(propylene terephthalate), poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), and mixtures thereof.

14. The composition in accordance with claim 12 wherein the composition has additional polymer component therein.

15. The composition in accordance with claim 13 wherein the composition has additional polymer component therein.

16. A composition comprising a reaction product of (1) a polyester component polyester selected from the group consisting of poly(1,4-butylene terephthalate), poly(ethylene naphthanoate), poly(butylene naphthanoate), poly(propylene terephthalate), poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), and mixtures thereof and (2) an epoxysilane, the product of said reaction having improved at least one of the properties of impact strength, color, and tensile modulus;
wherein the impact strength is at least 10%, as compared to a reaction product that does not contain the epoxy silane, measured with Notched IZOD or DYNATUP impact testing techniques a tensile modulus that is at least 5%, as compared to a reaction product that does not contain the epoxy silane, measured with tensile testing techniques.

17. The composition of claim 16, wherein the reaction product is opaque and the reaction product has a reduced Yellowness Index by Reflectance (YIR) of at least two units, as compared to a reaction product that does not contain the epoxy silane.

18. The composition of claim 16, wherein the reaction product is transparent and the reaction product has a reduced Yellowness Index (YI) of at least one unit, as compared to a reaction product that does not contain the epoxy silane.

19. A process comprising reacting a polyester with an epoxy silane under reactive conditions.
